(19) United States
(12) Patent Application Publication
(10) Pub. No.: US 2018/0371293 A1
(43) Pub. Date: Dec. 27, 2018

(54) POLISHING COMPOSITION FOR MAGNETIC DISK SUBSTRATE

(71) Applicant: YAMAGUCHI SEIKEN KOGYO CO., LTD., Aichi (JP)

(72) Inventor: Junichiro ANDO, Aichi (JP)

(73) Assignee: YAMAGUCHI SEIKEN KOGYO CO., LTD., Aichi (JP)

(21) Appl. No.: 16/012,492

(22) Filed: Jun. 19, 2018

(30) Foreign Application Priority Data
Jun. 22, 2017 (JP) 2017-122314

(51) Int. Cl. C09G 1/02; C09K 3/14; G11B 5/84

(52) U.S. Cl. CPC C09G 1/02; G11B 5/8404; C09K 3/1409

(57) ABSTRACT

Embodiments of the subject application provide a polishing composition for a magnetic disk substrate, whereby the polishing composition contains colloidal silica, at least one of a phosphorus-containing inorganic acid and an organic acid, and water. According to at least one embodiment, the colloidal silica in the polishing composition has an average particle diameter (D50) in the range of 5 to 50 nm observed by a transmission electron microscope. In measuring a volume-based particle size distribution of the colloidal silica by dynamic light scattering, when the particle size distribution is measured by adjusting a concentration of colloidal silica particles to be 0.25 mass %, the colloidal silica contains 10 vol % or less of colloidal silica particles larger than 50 nm. According to at least one embodiment, the polishing composition has 1 to 50 mass % of the colloidal silica, and the polishing composition has the pH (25° C.) in the range of 0.1 to 4.0.

### CROSS REFERENCE TO RELATED APPLICATIONS

This application claims the benefit of and priority to Japanese Patent Application No. JP-2017-122314, filed on Jun. 22, 2017, with Japanese Patent Office, the entire contents of which are incorporated herein by reference.

### BACKGROUND

### Field

Embodiments relate to a polishing composition used for polishing an electronic component such as a magnetic recording medium including a hard disc. Particularly, embodiments relate to a polishing composition for a magnetic disc substrate used for polishing a surface of a substrate for a magnetic recording medium such as a glass magnetic disc substrate or an aluminum magnetic disc substrate. Furthermore, embodiments relate to a polishing composition for a magnetic disc substrate preferably used for finish polishing of an aluminum magnetic disc substrate for a magnetic recording medium, having an electroless nickel-phosphorus plated film formed on a surface of an aluminum alloy substrate.

### Description of the Related Art

Conventionally, as a polishing composition for polishing a surface of an electroless nickel-phosphorus plated film of an aluminum magnetic disc substrate, improvement of various polishing characteristics has been desired in order to improve a magnetic recording density. For example, as for a scratch, a scratch portion may cause an error in writing or reading, or burr generated around a scratch may cause head crash or the like.

Therefore, colloidal silica has come to be used for finish polishing of an aluminum magnetic disc substrate, as an abrasive grain component playing a role of mechanical polishing of a polishing composition from a viewpoint of reduction in scratches. At this time, in industrial polishing, an abrasive grain component playing a role of mechanical polishing of a polishing composition and a chemical component playing a role of chemical polishing are mixed immediately before actual polishing to be used in many cases.

However, when colloidal silica as an abrasive grain component and a chemical component are mixed, the colloidal silica tends to be aggregated. As countermeasures for this problem, a trial to reduce scratches has been performed by removing a coarse particle or an aggregated particle, adjusting the shape of a particle, or adjusting corrosiveness of a polishing agent. For example, adjustment of corrosiveness of a polishing agent (Patent Document 1), adjustment of the shape of a particle (Patent Document 2), and adjustment of the content of an aggregated particle (Patent Document 3) have been proposed.
[Patent Document 1] JP-A-2009-120850
[Patent Document 2] JP-A-2009-172709
[Patent Document 3] JP-A-2010-170650

### SUMMARY

From a viewpoint of improving density of magnetic recording, reduction of halation and reduction of variations of waviness have been required as well as reduction of scratches.

The term “halation” herein is detected, as minute defects on a substrate surface, under specific test conditions by a disk surface inspection system (NS 2000H manufactured by Hitachi High-Tech Fine Systems Corporation) which is to be described in Example, and the “halation” is quantitatively determined as a halation count. It is considered that halation is a phenomenon caused by some fine unevenness over a wide area of a substrate surface. The possible reason for the fine unevenness is inconcinnity of characteristics possessed by a polishing pad, a carrier, a substrate, and a polishing composition. Recently, it has been newly found that halation is an obstructive factor for improvement in density of magnetic recording, which leads to demands for reduction of halation.

With regard to waviness, it has been required in the related art to reduce an average value of waviness in the entire substrate surface. In addition, the average value and variations of waviness may tend to increase from the center to the periphery of the substrate surface, and this is also an obstructive factor for improvement in density of magnetic recording.

An object of the various embodiments of the subject application is to provide a polishing composition for a magnetic disk substrate capable of reducing halation and reducing variations of waviness in a substrate after polishing without lowering productivity.

As a result of intensive studies to solve the above problems, the inventors have found that using the following polishing composition for a magnetic disk substrate makes it possible to reduce halation and reduce variations of waviness without lowering productivity, thereby completing the various embodiments.

According to at least embodiment, there is provided a polishing composition for a magnetic disk substrate containing colloidal silica, at least one of a phosphorus-containing inorganic acid and an organic acid, and water, whereby the colloidal silica has an average particle diameter (D50) in the range of 5 to 50 nm observed by a transmission electron microscope, in measuring a volume-based particle size distribution of the colloidal silica by dynamic light scattering, when the particle size distribution is measured by adjusting a concentration of colloidal silica particles to be 0.25 mass %, the colloidal silica contains 10 vol % or less of colloidal silica particles larger than 50 nm, the polishing composition has 1 to 50 mass % of the colloidal silica, and the polishing composition has the pH (25° C.) in the range of 0.1 to 4.0.

According to at least embodiment, the phosphorus-containing inorganic acid is at least one type of compound selected from the group consisting of phosphoric acid, phosphonic acid, phosphinic acid, pyrophosphoric acid, and tripolyphosphoric acid.

According to at least embodiment, the phosphorus-containing organic acid is at least one type of compound selected from the group consisting of 2-aminoethylphosphonic acid, 1-hydroxyethylidene-1,1-diphosphonic acid, aminotri (methylenephosphonic acid), ethylenediaminetetra (methylenephosphonic acid), diethylenetriaminepenta (methylenephosphonic acid), ethan-1,1-diphosphonic acid, ethan-1,1,2-triphosphonic acid, ethan-1-hydroxy-1,1,2-triphosphonic acid, ethan-1,2-dicarboxy-1,2-diphosphonic acid, methane hydroxyphosphonic acid, 2-phosphonobutan-1,2-dicarboxylic acid, 1-phosphonobutan-2,3,4-tricarboxylic acid, and α-methylphosphonosuccinic acid.

According to at least embodiment, the colloidal silica is stabilized by sodium or ammonium.

According to at least embodiment, the polishing composition further contains an oxidant.

According to at least embodiment, the polishing composition is used for finish polishing of an aluminum magnetic disk substrate plated with electroless nickel-phosphorus.

According to various embodiments, a polishing composition for a magnetic disk substrate is capable of reducing halation and reducing variations of waviness in a substrate after polishing while maintaining polishing rate.

### DETAILED DESCRIPTION

Various embodiments of the subject application will now be described. The various embodiments are not limited to the following but may be modified, corrected, or improved without departing from the scope of the invention.

1. Polishing Composition

A polishing composition for a magnetic disk substrate according to at least one embodiment contains colloidal silica, at least one of a phosphorus-containing inorganic acid and an organic acid, and water. The colloidal silica in the polishing composition has an average particle diameter (D50) in the range of 5 to 50 nm observed by a transmission electron microscope. In measuring a volume-based particle size distribution of the colloidal silica by dynamic light scattering, when the particle size distribution is measured by adjusting a concentration of colloidal silica particles to be 0.25 mass %, the colloidal silica contains 10 vol % or less of colloidal silica particles larger than 50 nm. Furthermore, the polishing composition has 1 to 50 mass % of the colloidal silica, and the polishing composition has the pH (25° C.) in the range of 0.1 to 4.0. The details will now be described.

1.1 Colloidal Silica

The colloidal silica contained in the polishing composition according to at least one embodiment has an average particle diameter of 5 to 50 nm. An average particle diameter of 5 nm or more prevents a decrease in polishing rate. An average particle diameter of 50 nm or less prevents exacerbation of surface roughness and scratches. The average particle diameter of the colloidal silica is measured as the Heywood diameter (the diameter of a circle with the same projected area) by analyzing a photograph taken by the transmission electron microscope, and the average particle diameter is the diameter (D50) at 50% from the small side in the (accumulated volume-based) cumulative particle size distribution.

Furthermore, in measuring a volume-based particle size distribution of the colloidal silica by dynamic light scattering, when the particle size distribution is measured by adjusting a concentration of colloidal silica particles to be 0.25 mass %, the colloidal silica contains 10 vol % or less of particles larger than 50 nm. More preferably, the colloidal silica contains 5 vol % or less of particles larger than 50 nm. In measuring a volume-based particle size distribution of the colloidal silica by dynamic light scattering, when the particle size distribution is measured by adjusting a concentration of colloidal silica particles to be 0.25 mass %, the colloidal silica contains 10 vol % or less of particles larger than 50 nm, so that it is possible to prevent exacerbation of halation.

When a particle size distribution is measured by dynamic light scattering in a low colloidal silica concentration (for example, 0.25 mass %), the particle size distribution of colloidal silica is not affected by aggregation of the colloidal silica, and obtained is a measurement result on the particle size distribution focusing on particularly large particles in the particle size distribution of the colloidal silica. In measuring a particle size distribution by dynamic light scattering, particulates having small particle diameters are likely to have weak scattering light intensity, so that it is more difficult to detect particulates having small particles diameters in a low colloidal silica concentration. Accordingly, as described above, obtained is a measurement result on the particle size distribution focusing on particularly large particles in the particle size distribution of the colloidal silica. Large particles in the particle size distribution of the colloidal silica detected under the above measurement conditions may be a possible reason for some fine unevenness on a substrate surface which is considered to cause halation during polishing.

On the other hand, a particle size distribution analyzed from the photograph taken by the transmission electron microscope is calculated based on the size of each particle, so that it may represent a particle size distribution of actual particles, but a range to be observed is limited to part of the particles in the polishing composition. Therefore, it is not possible to obtain a distribution focusing on larger particles including aggregated particles and the like.

A colloidal silica concentration in the polishing composition is 1 to 50 mass %. A colloidal silica concentration of 1 mass % or more prevents a decrease in polishing rate. A colloidal silica concentration of 50 mass % or less prevents deterioration in economic efficiency.

Colloidal silica is known to have a shape such as a spherical shape, a kompeito-typed shape (like particles having convexes on the surface), and a heteromorphic shape, and primary particles monodispersed in water forms a colloidal shape. The colloidal silica according to at least one embodiment is preferably spherical or nearly spherical. Colloidal silica is produced by a water glass method in which sodium silicate or potassium silicate is used as a raw material, or by an alkoxysilane method in which an alkoxysilane such as tetraethoxysilane is hydrolyzed with an acid or alkali.

A dispersion state of colloidal silica is such that fine primary particles are monodispersed in water. In a general production process of colloidal silica, after formation of colloidal silica particles by dehydration and condensation reaction of hydroxyl groups contained in silicic acid, stabilization is required by adding cations. Adding cations in colloidal silica slurry in a reaction system after formation of the colloidal silica particles increases the absolute value of negative charges on the surface of the colloidal silica particles, and the electrical repulsion makes it difficult for the particles to aggregate. Examples of cations (stabilizing ions) used for stabilizing the colloidal silica particles include sodium ion, potassium ion, ammonium ion, and tetramethylammonium ion. Among these stabilizing ions, the various embodiments preferably employ colloidal silica that includes sodium ion, being stabilized by sodium, and colloidal silica that includes ammonium ion, being stabilized by ammonium.

1.2 Phosphorus-Containing Inorganic Acid and/or Organic Acid

The phosphorus-containing inorganic acid and/or organic acid used according to at least one embodiment will now be described. Specific examples of the phosphorus-containing inorganic acid include phosphoric acid, phosphonic acid, phosphinic acid, pyrophosphoric acid, and tripolyphosphoric acid. Among these examples, phosphoric acid is preferably used.

Specific examples of the phosphorus-containing organic acid include 2-aminoethylphosphonic acid, 1-hydroxyethylidene-1,1-diphosphonic acid, aminotri (methylenephosphonic acid), ethylenediaminetetra (methylenephosphonic acid), diethylenetriaminepenta (methylenephosphonic acid), ethan-1,1-diphosphonic acid, ethan-1,1,2-triphosphonic acid, ethan-1-hydroxy-1,1,2-triphosphonic acid, ethan-1,2-dicarboxy-1,2-diphosphonic acid, methane hydroxyphosphonic acid, 2-phosphonobutan-1,2-dicarboxylic acid, 1-phosphonobutan-2,3,4-tricarboxylic acid, and α-methylphosphonosuccinic acid. Among these examples, 1-hydroxyethylidene-1,1-diphosphonic acid is preferably used.

In another preferred embodiment, two or more types of the above compounds are used in combination. Two or more types of phosphorus-containing inorganic acids may be used in combination, or two or more types of phosphorus-containing organic acids may be used in combination. Alternatively, two or more types of phosphorus-containing inorganic acids and phosphorus-containing organic acids may be combined. A specific example includes a combination of phosphoric acid and 1-hydroxyethylidene-1,1-diphosphonic acid.

The polishing composition preferably has a concentration of the phosphorus-containing inorganic acid and/or organic acid in the range of 0.1 to 20 mass %. More preferably, the concentration is 0.2 to 10 mass %. A concentration of 0.1 mass % or more ameliorates variations of waviness. A concentration of 20 mass % or less maintains sufficient polishing performance without using excessive phosphorus-containing inorganic acids and/or organic acids. The phosphorus-containing inorganic acid and/or organic acid content in the polishing composition is appropriately determined according to the setting of pH values.

1.3 Oxidant

According to at least one embodiment, an oxidant may be used as a polishing accelerator. Examples of the oxidant used herein include peroxide, permanganic acid or a salt thereof, chromic acid or a salt thereof, peroxoacid or a salt thereof, halogenoxoacid or a salt thereof, oxyacid or a salt thereof, and a mixture of two or more of these oxidants.

Specific examples include hydrogen peroxide, sodium peroxide, barium peroxide, potassium permanganate, a metallic salt of chromic acid, persulfuric acid, sodium persulfate, potassium persulfate, ammonium persulfate, peroxophosphoric acid, sodium peroxoborate, performic acid, peracetic acid, hypochlorous acid, sodium hypochlorite, and calcium hypochlorite. Among these examples, preferable examples are hydrogen peroxide, persulfuric acid and a salt thereof, and hypochlorous acid and a salt thereof, and hydrogen peroxide is particularly preferable. The oxidant content in the polishing composition is preferably 0.01 to 10.0 mass %. More preferably, the oxidant content is 0.1 to 5.0 mass %.

1.4 Other Ingredients

According to at least one embodiment, a water-soluble polymer compound, a buffer, an antiseptic, and the like may further be contained as required. Among these ingredients, a water-soluble polymer compound is used as necessary due to its auxiliary function for reducing halation and reducing variations of waviness without lowering productivity.

1.4.1 Water-Soluble Polymer Compound

Examples of the water-soluble polymer compound used as an optional component according to at least one embodiment include an anionic water-soluble polymer compound, a cationic water-soluble polymer compound, and a nonionic water-soluble polymer compound, and among these examples, an anionic water-soluble polymer compound is preferably used. Especially, a preferably example is a copolymer containing a structural units derived from a monomer having a carboxylic acid group, a structural units derived from a monomer having an amide group, and a structural units derived from a monomer having a sulfonic acid group. In other words, preferably used is a polymer compound copolymerized from a monomer having a carboxylic acid group and/or a salt thereof, a monomer having an amide group, and a monomer having a sulfonic acid group.

1.4.1.1 Monomer Having Carboxylic Acid Group

Examples of the monomer having a carboxylic acid group and/or a salt thereof include acrylic acid, methacrylic acid, maleic acid, itaconic acid, and salts of these acids.

With regard to the structural units derived from a monomer having a carboxylic acid group, at least a part of the structural units may be contained as a salt of a carboxylic acid in the water-soluble polymer compound. Examples of the salt of a carboxylic acid include sodium salt, potassium salt, magnesium salt, ammonium salt, amine salt, and alkylammonium salt.

In order to incorporate the structural units derived from a monomer having a carboxylic acid group as a carboxylic acid in the water-soluble polymer compound, the monomer having a carboxylic acid group may be polymerized, or a salt of the monomer having a carboxylic acid group may be polymerized and then converted into a carboxylic acid by exchanging cations. Furthermore, in order to incorporate the structural units derived from a monomer having a carboxylic acid group as a salt of a carboxylic acid in the water-soluble polymer compound, the salt of the monomer having a carboxylic acid group may be polymerized, or the monomer having a carboxylic acid group may be polymerized so as to form a salt of a carboxylic acid by neutralizing with a base.

In order to determine a proportion of the structural units contained as a carboxylic acid and the structural units contained as a salt of a carboxylic acid in the water-soluble polymer compound, a pH value of the water-soluble polymer compound may be used. When the pH value of the water-soluble polymer compound is low, it is determined that the proportion of the structural units contained as a carboxylic acid is high. On the other hand, when the pH value of the water-soluble polymer compound is high, it is determined that the proportion of the structural units contained as a salt of a carboxylic acid is high. According to at least one embodiment, it is possible to use, for example, a water-soluble polymer compound having a pH value (25° C.) of 1 to 13 in a water-soluble polymer compound aqueous solution having the concentration of 10 mass %.

1.4.1.2 Monomer Having Amide Group

As the monomer having an amide group, α, β-ethylenically unsaturated amides are preferably used. Specific examples include α,β-ethylenically unsaturated carboxylic acid amides such as acrylamides, methacrylamides, N-alkylacrylamides, and N-alkylmethacryl amides.

More preferred examples are N-alkylacrylamides, and N-alkylmethacrylamides. Preferred specific examples of N-alkylacrylamides, and N-alkylmethacrylamides include N-methylacrylamide, N-ethylacrylamide, N-n-propylacrylamide, N-iso-propylacrylamide, N-n-butylacrylamide, N-iso-butylacrylamide, N-sec-butylacrylamide, N-tert-butylacrylamide, N-methylmethacrylamide, N-ethylmethacrylamide, N-n-propylmethacrylamide, N-iso-propylmethacrylamide, N-n-butylmethacrylamide, N-iso-butylmethacrylamide, N-sec-butylmethacrylamide, and N-tert-butylmethacrylamide.

Among these examples, particularly preferred are N-n-butylacrylamide, N-iso-butylacrylamide, N-sec-butylacrylamide, N-tert-butylacrylamide, N-n-butylmethacrylamide, N-iso-butylmethacrylamide, N-sec-butylmethacrylamide, and N-tert-butylmethacrylamide.

1.4.1.3 Monomer Having Sulfonic Acid Group

Specific examples of the monomer having a sulfonic acid group include isoprenesulfonic acid, 2-acrylamido-2-methylpropanesulfonic acid, 2-methacrylamido-2-methylpropanesulfonic acid, styrenesulfonic acid, vinylsulfonic acid, allylsulfonic acid, isoamylenesulfonic acid, and naphthalenesulfonic acid. Among these examples, preferable examples are 2-acrylamido-2-methylpropanesulfonic acid, and 2-methacrylamido-2-methylpropanesulfonic acid.

1.4.1.4 Copolymer

The water-soluble polymer compound according to at least one embodiment is preferably a copolymer obtained by combining and polymerizing these monomer components. In the copolymer, preferably used are a combination of acrylic acid and/or a salt thereof and N-alkylacrylamide, a combination of acrylic acid and/or a salt thereof and N-alkylmethacrylamide, a combination of methacrylic acid and/or a salt thereof and N-alkylacrylamide, a combination of methacrylic acid and/or a salt thereof and N-alkylmethacrylamide, a combination of acrylic acid and/or a salt thereof and N-alkylacrylamide and a monomer having sulfonic acid group, a combination of acrylic acid and/or a salt thereof and N-alkylmethacrylamide and a monomer having sulfonic acid group, a combination of methacrylic acid and/or a salt thereof and N-alkylacrylamide and a monomer having sulfonic acid group, and a combination of methacrylic acid and/or a salt thereof and N-alkylmethacrylamide and a monomer having sulfonic acid group.

Particularly, among these examples, preferably used is a compound in which the alkyl group of N-alkylacrylamide or N-alkylmethacrylamide is at least one selected from the group consisting of an n-butyl group, an iso-butyl group, a sec-butyl group, and a tert-butyl group.

The proportion of the structural units derived from a monomer having a carboxylic acid group and the structural units derived from a monomer having an amide group in the water-soluble polymer compound is preferably in the range of 95:5 to 5:95 in mole ratio, more preferably 90:10 to 10:90 in mole ratio, as a quantitative ratio of the structural units derived from a monomer having a carboxylic acid group and the structural units derived from a monomer having an amide group. The proportion of the structural units derived from a monomer having a sulfonic acid group in the copolymer is preferably in the range of 0.01 to 10 mol %.

1.4.1.5 Production Method of Water-Soluble Polymer Compound

A production method of a water-soluble polymer compound is not particularly limited, but aqueous solution polymerization is preferable. According to the aqueous solution polymerization, it is possible to obtain a water-soluble polymer compound as a homogeneous solution. An aqueous solvent, particularly water, is preferable as a polymerization solvent for the aqueous solution polymerization. In order to improve solubility of the aforementioned monomer components in the solvent, an organic solvent may be appropriately added within a range where the polymerization of each monomer is not negatively affected. Examples of the organic solvent include alcohols such as isopropyl alcohol, and ketones such as acetone. These organic solvents may be used singly or in combination of two or more.

Hereinafter, the production method of a water-soluble polymer compound using the aforementioned aqueous solvent will be described. In a polymerization reaction, a known polymerization initiator may be used. Particularly, a radical polymerization initiator is preferably used.

Examples of the radical polymerization initiator include persulfates such as sodium persulfate, potassium persulfate, and ammonium persulfate; hydroperoxides such as t-butyl hydroperoxide; water-soluble peroxides such as hydrogen peroxide; ketone peroxides such as methylethylketone peroxide, and cyclohexanone peroxide; oil-soluble peroxides of dialkyl peroxides such as di-t-butyl peroxide, and t-butylcumyl peroxide; and azo compounds such as azobisisobutyronitrile, and 2,2-azobis(2-methylpropionamidine) dihydrochloride. These peroxide-type radical polymerization initiators may be used singly or in combination of two or more. Among the aforementioned peroxide-type radical polymerization initiators, persulfates and azo compounds are preferable, and azobisisobutyronitrile is particularly preferable from a viewpoint that those initiators facilitate molecular weight control of a water-soluble polymer compound to be produced.

The amount of the radical polymerization initiator to be used is not particularly limited, but it is preferable to use 0.1 to 15 mass % of the initiator, preferably 0.5 to 10 mass % of the initiator, based on the total mass of all monomers in the water-soluble polymer compound. A copolymerization ratio can improve by 0.1 mass % or more of the initiator, and the stability of the water-soluble polymer compound can improve by 15 mass % or less of the initiator.

In some cases, a water-soluble polymer compound may be produced with a water-soluble redox type polymerization initiator. Examples of the redox type polymerization initiator include a combination of an oxidant (for example, the aforementioned peroxides), and a reducing agent such as sodium bisulfite, ammonium bisulfite, ammonium sulfite, and sodium hydrosulfite, or a combination of an oxidant and iron alum or potassium alum, and the like.

In production of a water-soluble polymer compound, a chain transfer agent may be appropriately added to a polymerization system in order to adjust the molecular weight. Examples of the chain transfer agent include sodium phosphite, sodium hypophosphite, potassium hypophosphite, sodium sulfite, sodium bisulfite, mercaptoacetic acid, mercaptopropionic acid, thioglycolic acid, 2-propanethiol, 2-mercaptoethanol, and thiophenol.

A polymerization temperature at the time of producing the water-soluble polymer compound is not particularly limited, but the polymerization temperature is preferably 60 to 100° C. A polymerization temperature at 60° C. or more smoothes a polymerization reaction and excels the productivity, and a polymerization temperature at 100° C. or less suppresses coloring.

A polymerization reaction can be carried out under an increased or reduced pressure, but is preferably carried out at a normal pressure because of cost of equipment for a reaction under an increased or reduced pressure. Polymerization time is preferably from 2 to 20 hours, and is particularly preferably about from 3 to 10 hours.

After the polymerization reaction, if necessary, neutralization is carried out with a basic compound. Examples of the basic compound used for neutralization include alkali metal hydroxides such as sodium hydroxide, and potassium hydroxide; alkaline-earth metal hydroxides such as calcium hydroxide, and magnesium hydroxide; and ammonia water; and organic amines such as monoethanolamine, diethanolamine, and triethanolamine. Among these examples, ammonia water is preferable from a viewpoint of dispersibility of the water-soluble polymer compound produced and avoiding contamination of a substrate to be polished. In a case where an aqueous solution contains 10 mass % of the water-soluble polymer compound, a pH value (25° C.) after neutralization is preferably 2 to 9, more preferably 3 to 8.

1.4.1.6 Weight-Average Molecular Weight of Water-Soluble Polymer Compound

The weight-average molecular weight of the water-soluble polymer compound is preferably 1,000 or more and 2,000,000 or less, more preferably 2,000 or more and 1,000,000 or less. The weight-average molecular weight of the water-soluble polymer compound is measured in terms of polyacrylic acid by gel permeation chromatography (GPC).

1.4.1.7 Concentration of Water-Soluble Polymer Compound

The concentration of the water-soluble polymer compound in the polishing composition is preferably 0.0001 mass % or more and 2.0 mass % or less in solid content, more preferably 0.001 mass % or more and 1.0 mass % or less, still more preferably 0.005 mass % or more and 0.5 mass % or less, and still more preferably 0.01 mass % or more and 0.3 mass % or less.

2. Physical Properties (pH) of Polishing Composition

The polishing composition according to at least one embodiment has a pH value (25° C.) in the range of 0.1 to 4.0. Preferably, the pH value is 0.5 to 3.0. The polishing composition having a pH value (25° C.) of 0.1 or more prevents surface roughness. The polishing composition having a pH value (25° C.) of 4.0 or less prevents a decrease in polishing rate.

The polishing composition according to at least one embodiment can be used for polishing various electronic components of magnetic recording media such as hard disks. In particular, it is suitably used for polishing of an aluminum magnetic disk substrate. More preferably, the polishing composition according to at least one embodiment can be used for finish polishing of an aluminum magnetic disk substrate plated with electroless nickel-phosphorus. Electroless nickel-phosphorus plating is typically carried out at a pH value (25° C.) of 4 to 6. When the pH value (25° C.) is 4 or less, nickel tends to dissolve, which creates difficulty in electroless nickel-phosphorus plating. In contrast, in terms of polishing, for example, nickel tends to dissolve when the pH value (25° C.) is 4.0 or less so that using the polishing composition according to at least one embodiment enhances the polishing rate.

3. Polishing Method of Magnetic Disk Substrate

The polishing composition according to at least one embodiment is suitable for use in polishing of a magnetic disk substrate such as an aluminum magnetic disk substrate and a glass magnetic disk substrate. In particular, the polishing composition according to at least one embodiment is suitable for use in finish polishing of an aluminum magnetic disk substrate plated with electroless nickel-phosphorus (hereinafter referred to as an “aluminum disk”).

An example of a polishing method applicable to the polishing composition according to at least one embodiment includes one in which a polishing pad is attached to a surface plate of a polishing machine, and a polishing composition is fed to a surface of an object to be polished (for example, an aluminum disk) or to the polishing pad so as to rub the surface to be polished with the polishing pad (this method is called “polishing”). For example, when simultaneously polishing the front surface and the back surface of an aluminum disk, there is a technique of using a double-sided polishing machine with polishing pads being attached to an upper surface plate and a lower surface plate. In this technique, the aluminum disk is sandwiched between the polishing pads attached to the upper surface plate and the lower surface plate, and a polishing composition is fed between surfaces to be polished and the polishing pads, and the two polishing pads are rotated simultaneously so as to polish the front surface and the back surface of the aluminum disk. As for the polishing pads, urethane type, suede type, nonwoven fabric type, and any other types may be used.

### Examples

Hereinafter, the various embodiments will be specifically described based on Examples, but the various embodiments are not limited to these Examples, and it is a matter of course that the various embodiments may be carried out in various modes within the technical scope of the invention.

In polishing in each of the following Examples and Comparative Examples, prepared was an aluminum alloy substrate plated with electroless nickel-phosphorus and roughly polished in advance. The substrate was then subjected to finish polishing. Table 1 shows evaluation results of each polishing rate at the time of finish polishing, scratches and halation on each substrate after polishing, waviness at the periphery of each substrate, and the like.

Preparation Method of Polishing Composition

Polishing compositions used in Examples 1 to 12, and Comparative Examples 1 to 4 are ones that contain the following materials in the following content. In all Examples and Comparative Examples, the polishing composition was prepared so as to have 5.6 mass % colloidal silica content.

Colloidal silica A is a commercialized product which has an average particle diameter (D50) of 24 nm observed by the transmission electron microscope, having 0.5 vol % of particles larger than 50 nm measured by dynamic light scattering, and including sodium as a stabilizing ion. The colloidal silica A was used in Examples 1 and 2, and Comparative Examples 3 and 4.

Colloidal silica B is a commercialized product which has an average particle diameter (D50) of 24 nm observed by the transmission electron microscope, having 1.5 vol % of particles larger than 50 nm measured by dynamic light scattering, and including sodium as a stabilizing ion. The colloidal silica B was used in Example 3.

Colloidal silica C is a commercialized product which has an average particle diameter (D50) of 24 nm observed by the transmission electron microscope, having 6.0 vol % of particles larger than 50 nm measured by dynamic light scattering, and including sodium as a stabilizing ion. The colloidal silica C was used in Example 4.

Colloidal silica D is a commercialized product which has an average particle diameter (D50) of 30 nm observed by the transmission electron microscope, having 1.5 vol % of particles larger than 50 nm measured by dynamic light scattering, and including sodium as a stabilizing ion. The colloidal silica D was used in Examples 5 and 6.

Colloidal silica E is a commercialized product which has an average particle diameter (D50) of 30 nm observed by the transmission electron microscope, having 3.0 vol % of particles larger than 50 nm measured by dynamic light scattering, and including sodium as a stabilizing ion. The colloidal silica E was used in Example 7.

Colloidal silica F is a commercialized product which has an average particle diameter (D50) of 30 nm observed by the transmission electron microscope, having 6.0 vol % of particles larger than 50 nm measured by dynamic light scattering, and including sodium as a stabilizing ion. The colloidal silica F was used in Example 8.

Colloidal silica G is a commercialized product which has an average particle diameter (D50) of 24 nm observed by the transmission electron microscope, having 0.5 vol % of particles larger than 50 nm measured by dynamic light scattering, and including ammonium as a stabilizing ion. The colloidal silica G was used in Example 9.

Colloidal silica H is a commercialized product which has an average particle diameter (D50) of 24 nm observed by the transmission electron microscope, having 0.5 vol % of particles larger than 50 nm measured by dynamic light scattering, and including potassium as a stabilizing ion. The colloidal silica H was used in Example 10.

Colloidal silica I is a commercialized product which has an average particle diameter (D50) of 30 nm observed by the transmission electron microscope, having 1.5 vol % of particles larger than 50 nm measured by dynamic light scattering, and including ammonium as a stabilizing ion. The colloidal silica I was used in Example 11.

Colloidal silica J is a commercialized product which has an average particle diameter (D50) of 30 nm observed by the transmission electron microscope, having 1.5 vol % of particles larger than 50 nm measured by dynamic light scattering, and including potassium as a stabilizing ion. The colloidal silica J was used in Example 12.

Colloidal silica K is a commercialized product which has an average particle diameter (D50) of 24 nm observed by the transmission electron microscope, having 11.0 vol % of particles larger than 50 nm measured by dynamic light scattering, and including sodium as a stabilizing ion. The colloidal silica K was used in Comparative Example 1.

Colloidal silica L is a commercialized product which has an average particle diameter (D50) of 30 nm observed by the transmission electron microscope, having 15.0 vol % of particles larger than 50 nm measured by dynamic light scattering, and including sodium as a stabilizing ion. The colloidal silica L was used in Comparative Example 2.

The phosphoric acid content was adjusted so that the polishing composition had the pH (25° C.) of 1.6. Phosphoric acid was used in Examples 1 to 12, and Comparative Examples 1 and 2.

The sulfuric acid content was adjusted so that the polishing composition had the pH (25° C.) of 1.6. Sulfuric acid was used in Comparative Example 3.

The nitric acid content was adjusted so that the polishing composition had the pH (25° C.) of 1.6. Nitric acid was used in Comparative Example 4.

HEDP (1-hydroxyethylidene-1,1-diphosphonic acid) was added so that the HEDP content in the polishing composition became 0.2 mass %. HEDP was used in Examples 2 and 6.

Hydrogen peroxide was added so that the hydrogen peroxide content in the polishing composition became 0.6 mass %. Hydrogen peroxide was used in Examples 1 to 12, and Comparative Examples 1 to 4.

Average Particle Diameter (D50) of Colloidal Silica Observed by Transmission Electron Microscope

The particle diameter of the colloidal silica was measured as the Heywood diameter (projected area equivalent circular diameter) by taking a photograph in a visual field at a magnitude of 100,000 with the transmission electron microscope (TEM) (JEM 2000 FX (200 kV), manufactured by JEOL Ltd.) and by analyzing this photograph with analysis software (Mac-View Ver. 4.0, manufactured by Mountech Co., Ltd.).

The average particle diameter (D50) of the colloidal silica is determined by analyzing the particle diameters of about 2000 particles of colloidal silica by the above method and calculating the particle diameter at 50% from the small side in the accumulated particle size distribution (based on accumulated volume) using the aforementioned analysis software (Mac-View Ver. 4.0, manufactured by Mountech Co., Ltd.).

Particle Size Distribution of Colloidal Silica Measured by Dynamic Light Scattering, Proportion of Particles Larger than 50 nm

Measurement was carried out with a device for measuring a particle size distribution by dynamic light scattering (Nanotrac Wave II, manufactured by MicrotracBEL Corp.). A colloidal silica particle-dispersed liquid sample for measurement was prepared by iluting a colloidal silica particle-dispersed liquid before mixing with various chemicals with pure water so that the colloidal silica particle concentration became 0.25% and by stirring the diluted liquid well. In the volume-based cumulative particle size distribution from the small side, the accumulated volume frequency at 50 nm was determined, and based on the result, the proportion of particles larger than 50 nm was obtained.

Polishing Conditions

An aluminum disk having an outer diameter of 95 mm plated with electroless nickel-phosphorus was roughly polished and used as an object to be polished, thereby carrying out polishing.

Polishing machine: 9B double-sided polishing machine manufactured by Speedfam Company Limited

Polishing pad: pad for P2, manufactured by FILWEL Co., Ltd.

Surface plate rotation speed: upper surface plate −8.3 min′ lower surface plate 25.0 min⁻¹

Feed rate of polishing composition: 100 ml/min

Time of polishing: 300 seconds

Processing pressure: 11 kPa

Each component was mixed to prepare a polishing composition which was then introduced into the polishing machine through a filter having an opening of 0.45-μm so as to conduct a polishing test.

Evaluation on Disk Surface Polished

Polishing Rate Ratio

The polishing rate was calculated based on the following formula after measuring the mass of the aluminum disk which decreased after polishing.

Polishing rate (μm/min)=mass of aluminum disk which decreased (g)/time of polishing (min)/area of one side of aluminum disk (cm²)/density of electroless nickel-phosphorus plated film (g/cm³)/2×10⁴

In the above formula, the area of one side of the aluminum disk is 65.9 cm², and the density of the electroless nickel-phosphorus plated film is 8.0 g/cm³

The polishing rate ratio is a relative value when the polishing rate determined from the above formula in Comparative Example 1 is 1 (reference value). It should be noted that the polishing rate in Comparative Example 1 was 0.062 μm/min

Evaluation Method of Halation on Substrate Surface after Polishing

Halation was measured with NS 2000H, the disk surface inspection system manufactured by Hitachi High-Tech Fine Systems Corporation.

The measurement conditions are as follows.

PMT/APD Power Control Voltage

Hi-Light1: OFF

Hi-Light2: 900 V

Scan Pitch: 3 μm

Inner/Outer Radius: 18.0000-47.0000 mm

Positive Level: 76 mV

H2 White Spot Level: 80.0 mV

Halation is detected as minute defects on the substrate surface under the above inspection conditions and quantitatively evaluated as a halation count.

Halation Ratio

The halation ratio is a relative value when the halation count obtained from the above method in Comparative Example 1 is 1 (reference value). It should be noted that the halation count of Comparative Example 1 was 15,627.

Evaluation Method of Average Value and Variations of Waviness at Periphery of Substrate After Polishing

An average value and variations of waviness at the periphery of the substrate were measured with a three-dimensional optical profiler New View 8300 manufactured by AMETEK Inc.

The measurement conditions are as follows.

Lens: 10 times Mirau type

ZOOM: 1.0 times

Measurement Type: Surface

Measure Mode: CSI

Scan Length: 5 μm

Camera Mode: 1024×1024

Filter: Band Pass

Cut Off: Short 20.000 μm

Long: 100.000 μm

Measurement point

Radius: 46.15 mm

Angle: 36 points for every 10-degree

With regard to the waviness at the periphery of the substrate, determined were the average value and STDEV (standard deviation) of waviness at the 36 measurement points measured under the above measurement conditions.

TABLE 1

| | Colloidal silica | | | | | | | |
|---|---|---|---|---|---|---|---|---|
| | | | Proportion of particles | | | | | |
| | | | larger than 50 nm by | | | | | |
| | | Average particle | measuring particle | | | | | |
| | | diameter by | size distribution | | Acid | | | |
| Experimental | | TEM | by dynamic light | Stabilizing | Inorganic | Organic | pH | Polishing |
| example | Name | D50(nm) | scattering (vol %) | ion | acid | acid | (25° C.) | rate ratio |
| Example 1 | A | 24 | 0.5 | Sodium | Phosphoric acid | — | 1.6 | 0.90 |
| Example 2 | A | 24 | 0.5 | Sodium | Phosphoric acid | HEDP | 1.6 | 0.92 |
| Example 3 | B | 24 | 1.5 | Sodium | Phosphoric acid | — | 1.6 | 0.95 |
| Example 4 | C | 24 | 6.0 | Sodium | Phosphoric acid | — | 1.6 | 0.97 |
| Example 5 | D | 30 | 1.5 | Sodium | Phosphoric acid | — | 1.6 | 0.98 |
| Example 6 | D | 30 | 1.5 | Sodium | Phosphoric acid | HEDP | 1.6 | 0.98 |
| Example 7 | E | 30 | 3.0 | Sodium | Phosphoric acid | — | 1.6 | 1.02 |
| Example 8 | F | 30 | 6.0 | Sodium | Phosphoric acid | — | 1.6 | 1.02 |
| Example 9 | G | 24 | 0.5 | Ammonium | Phosphoric acid | — | 1.6 | 0.89 |
| Example 10 | H | 24 | 0.5 | Potassium | Phosphoric acid | — | 1.6 | 0.89 |
| Example 11 | I | 30 | 1.5 | Ammonium | Phosphoric acid | — | 1.6 | 0.97 |
| Example 12 | J | 30 | 1.5 | Potassium | Phosphoric acid | — | 1.6 | 0.97 |
| Comparative | K | 24 | 11.0 | Sodium | Phosphoric acid | — | 1.6 | 1.00 |
| Example 1 | | | | | | | | |
| Comparative | L | 30 | 15.0 | Sodium | Phosphoric acid | — | 1.6 | 1.05 |
| Example 2 | | | | | | | | |
| Comparative | A | 24 | 0.5 | Sodium | Sulfuric acid | — | 1.6 | 0.76 |
| Example 3 | | | | | | | | |
| Comparative | A | 24 | 0.5 | Sodium | Nitric acid | — | 1.6 | 0.69 |
| Example 4 | | | | | | | | |
| | | | | | | | Waviness | |
| | | | | | | | at periphery | |
| | | | | | | | of substrate (Å) | |
| | | | | | Experimental | Halation | Average | |
| | | | | | example | ratio | value | STDEV |
| | | | | | Example 1 | 0.02 | 0.256 | 0.004 |
| | | | | | Example 2 | 0.02 | 0.253 | 0.008 |
| | | | | | Example 3 | 0.03 | 0.257 | 0.008 |
| | | | | | Example 4 | 0.10 | 0.261 | 0.013 |
| | | | | | Example 5 | 0.09 | 0.253 | 0.008 |
| | | | | | Example 6 | 0.08 | 0.254 | 0.008 |
| | | | | | Example 7 | 0.14 | 0.255 | 0.007 |
| | | | | | Example 8 | 0.21 | 0.265 | 0.016 |
| | | | | | Example 9 | 0.03 | 0.251 | 0.007 |
| | | | | | Example 10 | 0.08 | 0.254 | 0.009 |
| | | | | | Example 11 | 0.09 | 0.257 | 0.01 |
| | | | | | Example 12 | 0.16 | 0.255 | 0.009 |
| | | | | | Comparative | 1.00 | 0.286 | 0.015 |
| | | | | | Example 1 | | | |
| | | | | | Comparative | 1.18 | 0.276 | 0.018 |
| | | | | | Example 2 | | | |
| | | | | | Comparative | 0.04 | 0.323 | 0.055 |
| | | | | | Example 3 | | | |
| | | | | | Comparative | 0.05 | 0.346 | 0.058 |
| | | | | | Example 4 | | | |

### DISCUSSION

From comparison between Comparative Example 1 versus Examples 1, 3 and 4, and comparison between Comparative Example 2 versus Examples 5, 7 and 8, it is found that halation improves substantially when proportion of colloidal silica particles larger than 50 nm measured by dynamic light scattering is 10 vol % or less. In addition, from comparison between Examples 1, 9, and 10, and comparison between Examples 5, 11, and 12, it is found that halation improves prominently when sodium and ammonium are used as the stabilizing ions.

Furthermore, from comparison between Comparative Examples 3 and 4 versus Examples 1 and 2, it is found that a case of using a phosphorus-containing inorganic acid and/or organic acid, the average value and variations of waviness at the periphery improves prominently, compared to a case of using sulfuric acid or nitric acid. In this case, it is also found that a case of using a phosphorus-containing inorganic acid and/or organic acid, the polishing rate improves. As seen from the above, using the polishing composition according to the various embodiments makes it possible to reduce halation after polishing and to observably reduce the average value and variations of waviness at the periphery.

A polishing composition according to various embodiments can be used for polishing electronic components of semiconductors and magnetic recording media such as hard disks. Particularly, the polishing composition can be used for surface polishing of a substrate for magnetic recording media such as a glass magnetic disk substrate and an aluminum magnetic disk substrate. The polishing composition can also be used for finish polishing of an aluminum magnetic disk substrate for magnetic recording media, having an electroless nickel-phosphorus plated film formed on a surface an aluminum alloy substrate.

What is claimed is:

1. A polishing composition for a magnetic disk substrate, comprising:
colloidal silica;
at least one of a phosphorus-containing inorganic acid and an organic acid; and
water,
wherein the colloidal silica has an average particle diameter (D50) in the range of 5 to 50 nm observed by a transmission electron microscope,
wherein in measuring a volume-based particle size distribution of the colloidal silica by dynamic light scattering, when the particle size distribution is measured by adjusting a concentration of colloidal silica particles to be 0.25 mass %, the colloidal silica contains 10 vol % or less of colloidal silica particles larger than 50 nm,
wherein the polishing composition has 1 to 50 mass % of the colloidal silica, and
wherein the polishing composition has the pH (25° C.) in the range of 0.1 to 4.0.

2. The polishing composition for the magnetic disk substrate according to claim 1, wherein the phosphorus-containing inorganic acid is at least one type of compound selected from the group consisting of phosphoric acid, phosphonic acid, phosphinic acid, pyrophosphoric acid, and tripolyphosphoric acid.

3. The polishing composition for the magnetic disk substrate according to claim 1, where the phosphorus-containing organic acid is at least one type of compound selected from the group consisting of 2-aminoethylphosphonic acid, 1-hydroxyethylidene-1,1-diphosphonic acid, aminotri (methylenephosphonic acid), ethylenediaminetetra (methylenephosphonic acid), diethylenetriaminepenta (methylenephosphonic acid), ethan-1,1-diphosphonic acid, ethan-1,1,2-triphosphonic acid, ethan-1-hydroxy-1,1,2-triphosphonic acid, ethan-1,2-dicarboxy-1,2-diphosphonic acid, methane hydroxyphosphonic acid, 2-phosphonobutan-1,2-dicarboxylic acid, 1-phosphonobutan-2,3,4-tricarboxylic acid, and α-methylphosphonosuccinic acid.

4. The polishing composition for the magnetic disk substrate according to claim 1, wherein the colloidal silica is stabilized by sodium or ammonium.

5. The polishing composition for the magnetic disk substrate according to claim 1, wherein the polishing composition further comprises an oxidant.

6. The polishing composition for the magnetic disk substrate according to claim 1, wherein the polishing composition is used for finish polishing of an aluminum magnetic disk substrate plated with electroless nickel-phosphorus.
